(19) United States
(12) Patent Application Publication
(10) Pub. No.: US 2014/0104854 A1
(43) Pub. Date: Apr. 17, 2014

(54) PRISM SHEET INCLUDING LIGHT EMITTING SURFACE WITH V-SHAPED GROOVES

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/727,592

(22) Filed: Dec. 27, 2012

(30) Foreign Application Priority Data
Oct. 17, 2012 (TW) 101138270

(51) Int. Cl. F21V 5/02

(52) U.S. Cl. CPC F21V 5/02
USPC 362/339

(57) ABSTRACT

A prism sheet includes a light incident surface and a light emitting surface opposite to the light incident surface. The light emitting surface defines a plurality of V-shaped grooves. A sub-wavelength grating is formed on the light emitting surface.

### BACKGROUND

1. Technical Field

The present disclosure relates to back light modules, and particularly, to a prism sheet used in the back light modules.

2. Description of Related Art

Prism sheets are usually used in back light modules for converging scattered light and enhancing brightness of a front side of the back light modules. FIG. 1 shows a conventional prism sheet 10. A refractive index of the prism sheet 10 is greater than that of air (about 1). When an incident angle θ₁ of light is greater than a total reflection angle of the prism sheet 10, the light will be reflected back and cannot be emitted out from an emitting surface 11 of the prism sheet 10. This reduces the brightness of the back light module.

Therefore, it is desired to provide a prism sheet which can overcome the above mentioned problems.

### BRIEF DESCRIPTION OF THE DRAWINGS

FIG. 1 is a schematic view of a prism sheet in related art.

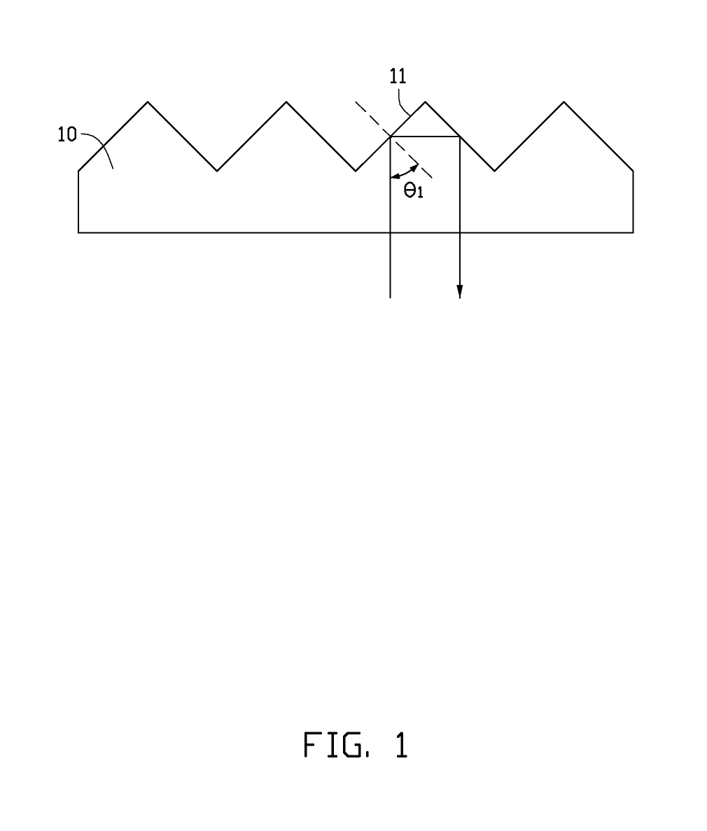

FIG. 2 is a schematic, isometric view of a prism sheet according to an embodiment.

FIG. 3 is a schematic view of the prism sheet of FIG. 2.

### DETAILED DESCRIPTION

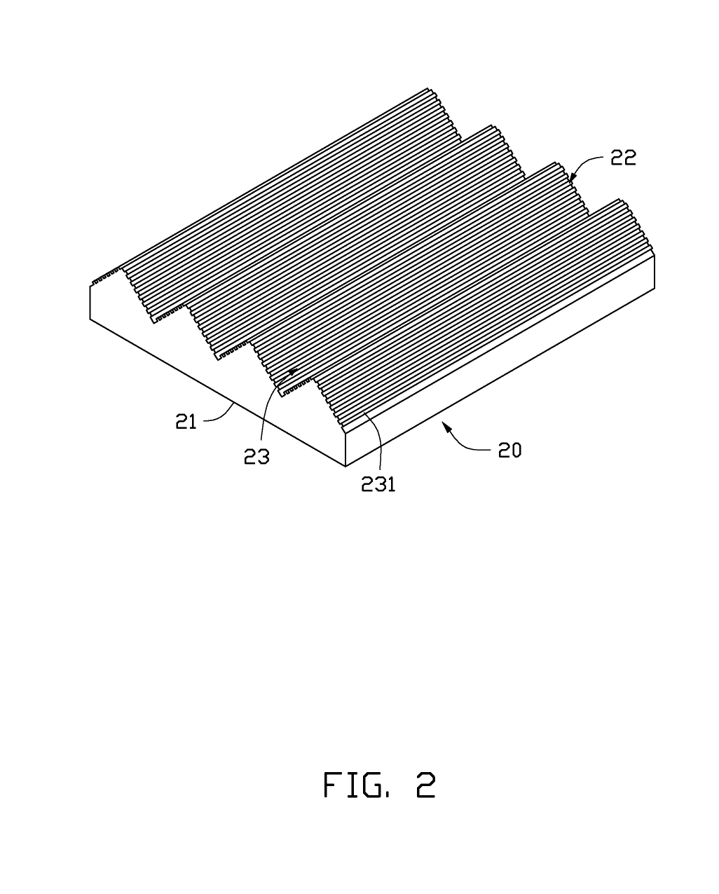

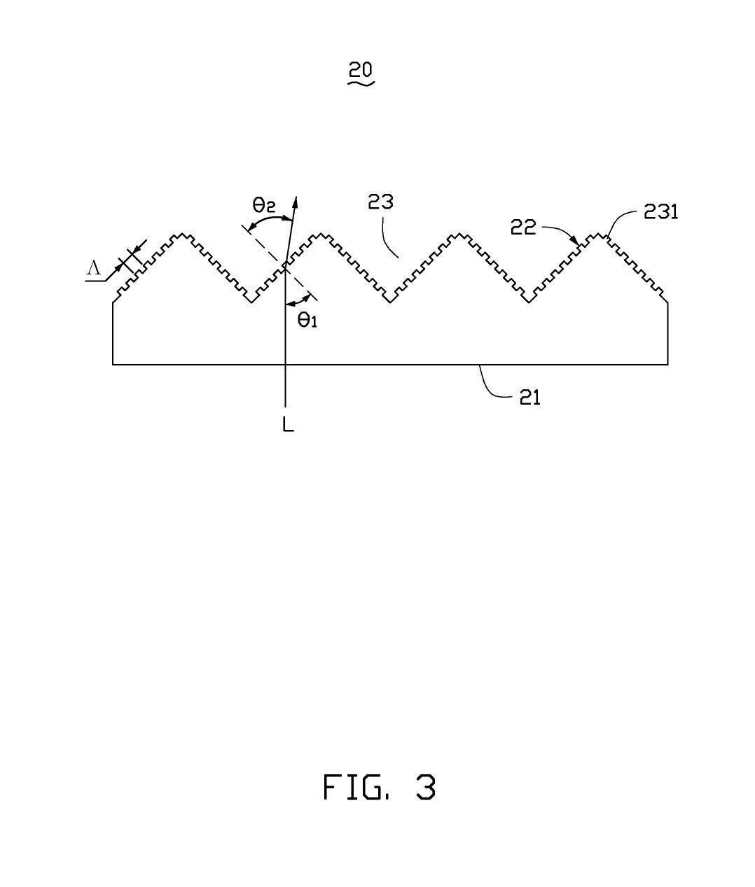

FIGS. 2 to 3 show a prism sheet 20. The prism sheet 20 is made of transparent material, such as transparent resin. In this embodiment, the prism sheet 20 is made of polymethyl methacrylate (PMMA), and a refractive index n₁ of the prism sheet 20 is about 1.5.

The prism sheet 20 includes a light incident surface 21 and a light emitting surface 22 opposite to the light incident surface 21. The light incident surface 21 is a flat surface. The light emitting surface 22 defines a number of V-shaped grooves 23. In cross section perpendicular to an extending direction of the V-shaped grooves 23, each groove 23 forms a right angle isosceles triangle. A sub-wavelength grating 231 is formed on the entire light emitting surface 22 in the V-shaped grooves 23. In this embodiment, a period A of the sub-wavelength grating 231 is 0.3 micrometers (um).

The sub-wavelength grating 231 allows more light to emit from the light emitting surface 22. For example, a light L is perpendicularly incident from the light incident surface 21. When the light reaches the light emitting surface 22, an incident angle θ₁ of the light on the light emitting surface 22 is equal to 45°. According to a refraction formula using n₁=1.5, a total reflection angle θ of the prism sheet 20 is 41.81°, which is smaller than the incident angle θ₁. Thus, the light would be reflected back rather than out from the light emitting surface 22 if not for the sub-wavelength grating 231. Yet, as there is the sub-wavelength grating 231, diffraction occurs and the light can emit from the light emitting surface 22 by diffraction as explained below.

According to a grating equation, mλ=Λ(n₂×sin θ₁−n₁×sin θ₂), wherein m is a diffraction order, λ is a wavelength of the light, Λ is the period of the sub-wavelength grating 231, n₁ is the refractive index of the prism sheet 20, θ₁ is the incident angle, n₂ is a refractive index of the air, and θ₂ is a diffractive angle. In this embodiment, m=−1, Λ=0.55 um, Λ=0.3 um, n₂=1, n₁=1.5, θ₁=45°, according to the grating equation, θ₂ is equal to 50.564°, thus, light even with an incident angle of 45° can emit from the light emitting surface 22.

The sub-wavelength grating 231 allows more light to emit from the light emitting surface 22. In this way, brightness of a back light module which includes the prism sheet 20 is enhanced.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A prism sheet comprising:
a light incident surface; and
a light emitting surface opposite to the light incident surface, wherein the light emitting surface defines a plurality of V-shaped grooves, and a sub-wavelength grating is formed on the light emitting surface.

2. The prism sheet of claim 1, wherein the prism sheet is made of transparent material.

3. The prism sheet of claim 2, wherein the transparent material is transparent resin.

4. The prism sheet of claim 1, wherein in cross section perpendicular to an extending direction of the V-shaped grooves, each of the V-shaped grooves is a right angle isosceles triangle in shape.

5. The prism sheet of claim 1, wherein a period of the sub-wavelength grating is 0.3 micrometers.

6. The prism sheet of claim 1, wherein the sub-wavelength grating is formed on the light emitting surface entirely.
